(19) United States
(12) Patent Application Publication
(10) Pub. No.: US 2026/0225925 A1
(43) Pub. Date: Aug. 6, 2026

(54) MITIGATING CHLORIDE ION OXIDATION DURING SALINE WATER ELECTROLYSIS FOR HYDROGEN PRODUCTION AND CARBON DIOXIDE MINERALIZATION

(71) Applicant: The Regents of the University of California, Oakland, CA (US)

(72) Inventors: Gaurav N. Sant, Los Angeles, CA (US); Xin Chen, Los Angeles, CA (US); Dante Adam Siminetti, Los Angeles, CA (US); David Jassby, Los Angeles, CA (US); Erika Callagon La Plante, Los Angeles, CA (US); Steven Bustillos, Los Angeles, CA (US); Thomas Traynor, Los Angeles, CA (US); Arnaud Bouissonnié, Los Angeles, CA (US)

(21) Appl. No.: 19/151,548

(22) PCT Filed: Jan. 31, 2024
(86) PCT No.: PCT/US2024/013806

§ 371 Date: Jul. 28, 2025

Related U.S. Application Data
(60) Provisional application No. 63/442,292, filed on Jan. 31, 2023.
(60) Provisional application No. 63/442,295, filed on Jan. 31, 2023.

(51) Int. Cl. C02F 1/461; B01D 53/62; B01D 53/78; C02F 1/28; C02F 1/42; C02F 1/44; C02F 9/00; C02F 101/12; C02F 103/10; C25B 1/04; C25B 9/19; C25B 11/052; C25B 11/063; C25B 11/077; C25B 13/02; C25B 13/07; C25B 13/08; C25B 15/08

(52) U.S. Cl. CPC C02F 1/4618; B01D 53/62; B01D 53/78; C02F 1/46109; C02F 9/00; C25B 1/04; C25B 9/19; C25B 11/052; C25B 11/063; C25B 11/077; C25B 13/02; C25B 13/07; C25B 13/08; C25B 15/085; C25B 15/087; B01D 2251/304; B01D 2251/402; B01D 2251/404; B01D 2251/604; B01D 2257/504; B01D 2258/0283; B01D 2258/06; C02F 1/281; C02F 1/42; C02F 2001/422; C02F 1/441; C02F 1/442; C02F 2001/46142; C02F 2101/12; C02F 2103/10; C02F 2201/46115; C02F 2201/4618; C02F 2301/046

(57) ABSTRACT

The present disclosure relates to methods of sequestering CO2 comprising a first cathodic chamber, performing a first alkaline process, a first anodic chamber, performing a first acidic process, and dechlorinating a solution by contacting the solution with a dechlorinating agent. Also provided herein are systems comprising a first cathodic chamber and a first anodic chamber.

### CROSS-REFERENCE TO RELATED APPLICATIONS

This application claims the benefit of priority to U.S. Provisional Application Nos. 63/442,292, filed Jan. 31, 2023, and 63/442,295, filed Jan. 31, 2023, the contents of each of which are hereby incorporated in their entirety.

### STATEMENT OF GOVERNMENT FUNDING

This invention was made with government support under DE-AR0001551 awarded by the U.S. Department of Energy. The government has certain rights in the invention.

### BACKGROUND

Efficient and cost effective means of sequestering CO₂, such as by mineralization, are highly desired as a critical component of combating global climate change. Alkaline solutions are known to react with CO₂ sources to produce CO₃²⁻ species, which may be isolated is stable solids, but there are a number of challenges to large-scale CO₂ sequestration using highly concentrated (e.g., industrially produced) alkaline solutions including cost of the alkalinizing reagents. For example, wastewater associated with oil and gas processing (known as “produced water”) contains mineral concentrations that are higher than those found in seawater and that are dictated by the relative concentrations of deposits at the well site. These produced water streams present a unique opportunity to sequester large amounts of CO₂, on a volume of water processed basis, with the increase in CO₂ sequestered per volume of water processed being proportional to the increase in mineral concentration. However, processing these waters also present challenges in the above-described electrolytic process; for example: 1) higher pH gradients across the anode-cathode cell; 2) higher rates/extents of oxidized chlorine evolution; 3) higher current densities; and/or 4) precipitation of undesirable minerals (e.g., NaCl). As an alternative, alkaline solutions may be prepared efficiently using water electrolysis, and separation of the resultant H⁺ (acidic) and OH⁻ (basic) species into acidic and basic solutions. However, the chlorine evolution reaction (CIER) is favored in solutions comprising Cl-ions, such as naturally occurring brines or seawater. The undesired CIER occurring in competition with the desired oxygen evolution reaction (OER) hinders the use of such processes for large-scale CO₂ capture, and more generally seawater electrolysis for hydrogen production. As such, there exists a need for electrolytic systems for CO₂ capture which mitigate the unwanted production of free chlorine species and chlorine gas.

### SUMMARY OF THE INVENTION

In certain aspects, provided herein are methods of sequestering CO₂, comprising an alkaline process, an acidic process, and a dechlorination process, whereby CO₂ is captured by an alkaline solution in the alkaline process, and free chlorine species generated during the acid process are eliminated or reduced by the dechlorination process. In certain embodiments, an anode that disfavors the generation of free chlorine species may be used.

In some aspects, provided herein are methods of sequestering CO₂ using saline solutions with high total dissolved solids (TDS) comprising at least one alkaline process, an acidic process, a dechlorination process, and a deacidification process, whereby a CO₂ source is contacted with an alkaline solution in the alkaline process, and free chlorine species generated during the acid process are eliminated or reduced by the dechlorination process. In certain embodiments, a selective anode may be used which prevents the generation of free chlorine species.

In certain aspects, provided herein are method of sequestering CO₂ comprising:
(a) in a first cathodic chamber, performing an alkaline process comprising:
   (i) alkalinizing a first solution by contacting the first solution with a cathode disposed inside the cathodic chamber, thereby forming an alkaline solution and H₂, wherein the first solution comprises water and divalent alkaline earth ions;
   (ii) contacting the alkaline solution with a CO₂ source, thereby forming a carbonated solution comprising a mixture of ionic compounds, wherein the ionic compounds comprise CO₃²⁻;
(b) in a first anodic chamber, performing an acidic process comprising:
   (i) acidifying a second solution comprising chloride ions by contacting the second solution with an anode disposed inside the anodic chamber, thereby forming an acidic solution; and
   (ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the cathodic chamber and the anodic chamber are in ionic communication; and
the acidic process and the alkaline process are performed simultaneously or sequentially.

In some aspects, provided herein are methods of sequestering CO₂ comprising:
(a) in a first cathodic chamber, performing a first alkaline process comprising:
   (i) alkalinizing a first solution by contacting the first solution with a cathode disposed within the first cathodic chamber, thereby forming an alkaline solution and producing H₂, wherein the first solution comprises water and divalent alkaline earth ions;
   (ii) contacting the alkaline solution with a CO₂ source, thereby forming a carbonated solution comprising a mixture of salts comprising OH and/or CO₃²⁻;
   (iii) precipitating the salts comprising OH and/or CO₃²⁻ from the carbonated solution;
(b) in a first anodic chamber, performing a first acidic process comprising:
   (i) acidifying a second solution comprising chloride ions by contacting the second solution with an anode disposed within the first anodic chamber, thereby forming an acidic solution; and
   (ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the first cathodic chamber and first anodic chamber are in ionic communication;
the first solution and second solution are aqueous solutions having greater than about 8 parts per thousand (ppt) total dissolved solids; and
the first acidic process and the first alkaline process are performed simultaneously or sequentially.

In certain aspects, provided herein are systems for the sequestration of CO₂ comprising:
(a) a first cathodic chamber comprising:
   a first cathode
   a first cathodic gas outlet;
   a first solution inlet; and
   a first alkaline solution outlet;
   wherein the first cathode is disposed inside the first cathodic chamber and coupled to
      a power source; and
(b) a first anodic chamber comprising:
   a first anode;
   a first anodic gas outlet;
   a second solution inlet; and
   a first acidic solution outlet;
   wherein the anode is disposed inside the anodic chamber and coupled to a power source;
wherein the first cathodic chamber and the first anodic chamber are in ionic communication.

### BRIEF DESCRIPTION OF THE DRAWINGS

FIG. 1 shows a simplified block flow diagram showing saline water electrolysis as a carbon removal pathway.

FIG. 2 shows the acid neutralization capacity (mol H⁺/kg solute) of various exemplary deacidifying agents of the disclosure, established on the basis of their chemical composition. In general, a smaller quantity (mass) of solute is used as acid neutralization capacity increases.

FIG. 3 shows the dechlorination capacity (mol Cl₂/kg solute) of various dechlorinating agents of the disclosure, established on the basis of their chemical composition. In general, a smaller quantity (mass) of solute is used as dechlorination capacity increases.

FIG. 4 shows a schematic drawing, in a cross-sectional view, of an exemplary flow-through, single-compartment electrolyzer.

FIG. 5 shows the pH of each of the effluents recorded at various time points from the system shown in FIG. 4.

FIG. 6 shows the chemical composition of the precipitated solids from the cathodic chamber of the system shown in FIG. 4.

FIG. 7 shows the inorganic carbon (IC, e.g., HCO₃⁻, CO₃²⁺) concentration over time by continuously aerating the catholyte and cathodic chamber with 400 ppm CO₂ gas mixture.

FIG. 8 shows the concentration of chlorine in the anolyte over time, and (inset) an exemplary Mn oxide-coated anode.

FIG. 9 shows the results of an exemplary continuously stirred reactor experiment using Forsterite-olivine and a hydraulic retention time of 10 minutes at varying solid/liquid ratios (50, 125, 250 g/L) with an acidified seawater (initial pH=2).

FIGS. 10-12 are schematics showing exemplary carbon immobilization and sequestration processes as described herein.

FIG. 13 shows the pH of each of the effluents recorded at various time points from the system shown in FIG. 4.

FIG. 14 shows a photo of the precipitated solids from the cathodic chamber of the system shown in FIG. 4.

FIG. 15 shows the X-ray diffraction pattern and chemical composition of the precipitated solids from the cathodic chamber of the system shown in FIG. 4.

FIG. 16 shows the scanning electron image of the precipitated solids from the cathodic chamber of the system shown in FIG. 4.

### DETAILED DESCRIPTION OF THE INVENTION

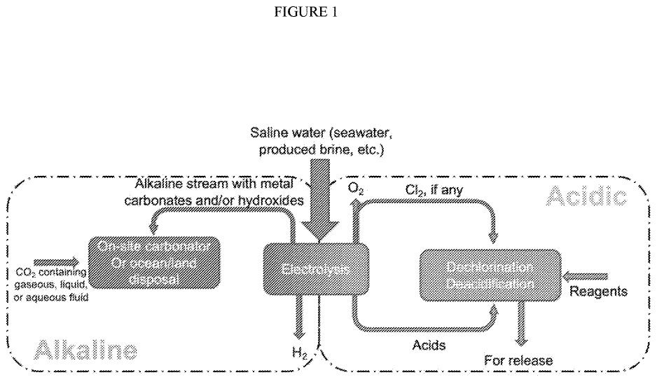

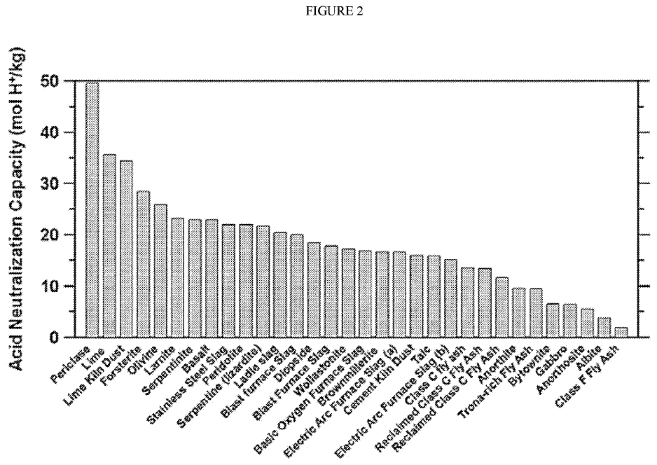

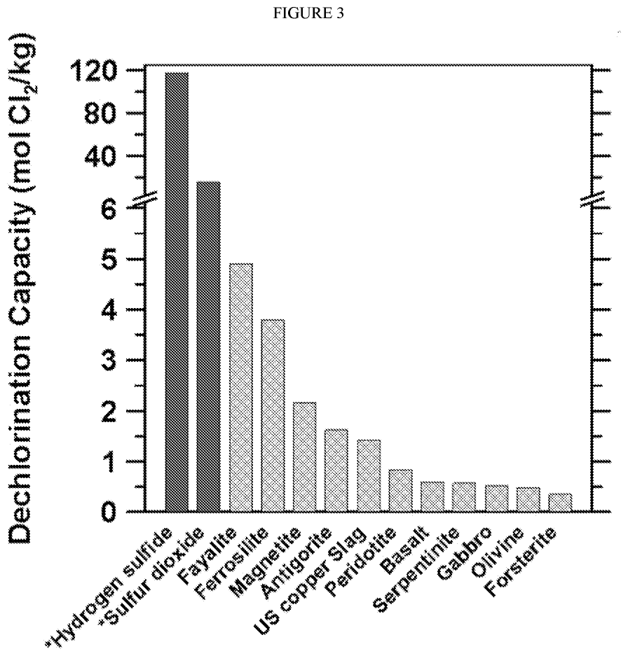

Electrochemical saline water alkalinization is a transformative approach for CO₂ removal and/or hydrogen production. For instance, seawater electrolysis-mediated carbon immobilization exploits: (i) the ocean-atmosphere equilibrium of gas-phase and dissolved CO₂ (~2 mM dissolved inorganic carbon, DIC), and (ii) the large abundance of divalent alkaline cations in seawater (55 mM Mg²⁺ and 10.5 mM Ca²⁺). These attributes can be leveraged to electrochemically force carbonate and hydroxide mineral formation (e.g., Ca—, Mg—carbonates, hydroxides and their variants), which consumes dissolved CO₂ and absorbs additional atmospheric CO₂ in the form of carbonates/bicarbonates. Electrolytic alkalinization may be effected without the need for costly alkali additives (e.g., NaOH), but instead by the electrochemical pH-swing of saline water in the proximity of flow-through electrode surfaces that produce hydroxide ions (OH) and promote heterogeneous and homogeneous nucleation and growth of carbonate and hydroxide mineral precipitates. However, saline water electrolysis is usually accompanied by the oxidation of chloride ions and the formation of free chlorine species (Cl₂, ClO⁻, and HClO), which occurs on the anode. Unless these species can be collected prior to discharge of electrolyzer effluents, chlorine oxidation is in general harmful and should be suppressed. Herein are provided methods and systems for the immobilization of CO₂ as solid and aqueous carbonate and bicarbonate species while inhibiting chloride ion oxidation reactions via 1) upstream strategies such as using oxygen evolution reaction (OER)-selective anodes, and/or 2) down-stream strategies such as chlorine scavenging processes. An exemplary, simplified flow diagram is denoted in FIG. 1, and the detailed strategies are respectively established on the catholyte (alkaline) and anolyte (acidic) sides.

### CO₂ Capture Using Alkaline Solutions

Saline water (e.g., seawater) alkalization can be induced at reasonable overpotentials (≤0.5 V) that yields locally-produced alkalinity (OH ions) at the cathode as a result of the hydrogen evolution reaction (HER):

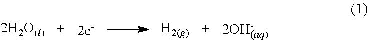

The reaction not only produces hydrogen that can be collected as a clean fuel, it also produces alkalinity that can then react with atmospheric or concentrated CO₂ (400 ppm to 100%):

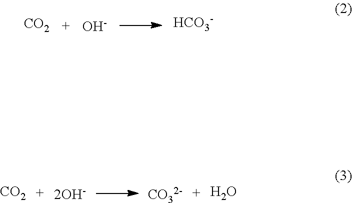

Alternatively, with the presence of multi-valent cations (e.g., Ca²⁺, Mg²⁺), the alkalinity (OH ions) combines with CO₂ to overcome the barriers to Ca— and Mg— based mineral precipitation. The net reaction for calcium and magnesium ions are:

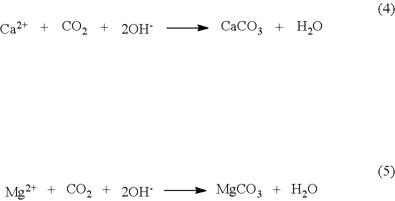

In many cases, CO₂ is trapped in the solid carbonate and/or hydroxycarbonate forms. On the other hand, the precipitation of calcium and magnesium carbonate could kinetically limited at low DIC concentrations (<10 mM), thus, alkalinity can also forces the precipitation hydroxides according to the following reactions:

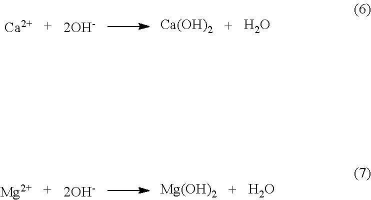

whose dissolution in water (e.g., seawater), can also result in atmospheric or concentrated CO₂ (400 ppm to 100%) drawdown as HCO₃/CO₃²⁻ ions (as indicated in Reactions 2-3). Strategies and conditions (e.g., direct hydroxide carbonation) for the formation of calcium and magnesium carbonates and hydroxycarbonates, e.g., calcite (CaCO₃), aragonite (CaCO₃), nesquehonite (MgCO₃·3H₂O), and hydromagnesite (Mg₅(CO₃)₄(OH)₂·4H₂O) can also be exploited, thereby resulting in solid CO₂ mineralization. In other embodiments, carbon is trapped in the dissolved (i.e., HCO₃⁻/CO₃²⁻ ions) form, whereby less alkalinity (OH) are needed for every mole of CO₂ mineralized. These conditions can be achieved by equilibrating the alkalinized saline water with air (i.e., 400 ppm CO₂) or concentrated CO₂ streams (400 ppm to 100%), yielding two limiting cases: (1) solid carbonate/hydroxycarbonate production (i.e., 100% solid CO₂ sequestration), and (2) aqueous CO₂ sequestration. Following the former, 1 mol of CO₂ is captured by 2 mol of hydroxyl ions (OH) to produce 1 mol CaCO₃, MgCO₃ or other alkali metal (Na, K, etc.) carbonates and bicarbonates. In case of the latter, every mol of hydroxide ions (OH—) leads to the absorption of 1-2 mol of CO₂ to form aqueous HCO₃⁻/CO₃²⁻ ions. CO₂ immobilization can be implemented by using carbonation liquid-phase, gas-phase, or mixed-phase reactors, or by deploying the alkaline products (solids and solutions) on land and/or ocean allowing for atmospheric CO₂ drawdown. In any case, products from CO₂ immobilization should fall within the two limiting cases and yield a combination of solid and aqueous carbonate species.

### Treatment of Anodic Products

On the other hand, acid will be produced at the anode from oxygen evolution reactions (OER):

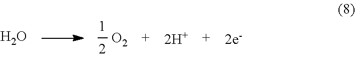

For (NaCl-containing) saline water electrolysis, the chlorine evolution reaction (CIER):

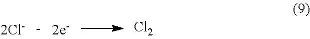

competes with the OER at the anode: OER is thermodynamically more favorable (i.e., initiate at lower potentials) but CIER is kinetically faster as fewer electron transfers are involved. At large scales, Cl₂ evolution and the formation of free-chlorine species (Cl₂, ClO⁻, HClO, etc.) are in general harmful and should be suppressed.

In certain embodiments, the anode is a manganese oxide-based (MnOₓ) anode. In certain such embodiments, to inhibit chlorine evolution, achieving less than 20% CIER efficiency and at least 80% OER efficiency. In general, the manganese oxides can be doped or functionalized with other transition metals (e.g., Mo, W, Fe, Co, Cr, Ru, Ir etc.) oxides for enhanced selectivity and durability. In addition, the manganese oxides based (MnOₓ—) catalysts can be directly coated (e.g., via electroplating, sol-gel coating, chemical/physical deposition, sintering, etc.) on a conductive substrate (e.g., metallic, metal oxide, or carbon-based), or it can be coated in-mix or on-top of other catalysts (e.g., pure or doped Ru- and Ir-oxides) to promote anode stability and conductivity.

### Modifications to Systems of the Disclosure

Naturally enhanced aeration of the catholyte can be conducted by disposing the catholyte and the produced hydroxide into the ocean or land to ensure effective mixing and CO₂ equilibration. If released into the ocean, the catholyte may act as a seawater alkalinization reagent to promote atmospheric CO₂ drawdown and to counter ocean acidification. In certain embodiments, carbonation of the catholyte can be performed in a separate carbonator or in the alkaline process chamber using atmospheric air or more concentrated CO₂ streams. As indicated in FIG. 5 a-b, example results show aeration of the catholyte and precipitates leads to CO₂ mineralization as both solid and aqueous species, even at a CO₂ concentration as low as 400 ppm (atmospheric).

### Aqueous Electrochemical Processes and Systems for Carbon Immobilization and Sequestration

Several strategies can be implemented to better utilize the mineral content of the feed stream. In certain embodiments, to limit the drawbacks associated with a higher pH gradient, the cell can be operated at a lower per pass conversion, while recycling the partially demineralized product back to the inlet. Recycle ratios should be calculated based on the ratio of calcium to magnesium, as magnesium will be largely removed in the first pass. The produced calcium and magnesium hydroxide can be subsequently exposed to carbon dioxide to be converted to mineral carbonates, sequestering carbon dioxide. In various embodiments, the aforementioned sequestering is performed in an air contactor, through a slurry or suspension separated from the product liquid, or directly through or within the product liquid.

In certain embodiments, the anolyte stream may also be neutralized before subsequent use or disposal. In certain embodiments, an ion exchange resin is used to neutralize the resulting high-pH anolyte stream. The high sodium content of the feed stream can be used to regenerate the resin. Free-chlorine species (e.g., dissolved chlorine gas, hypochlorite, and chlorate ions) are minimized by electrode selection (e.g., oxygen selective anodes), then removed by separation. Free-chlorine species degrade the capacity of the ion exchange resin.

In certain embodiments, the use of reverse osmosis (RO) or nanofiltration at the inlet of the system (where the aqueous solution has a pH of approximately 7) will provide a calcium-and magnesium-rich stream to the catholyte half of the cell, and a sodium rich stream to the ion exchange resin. Reverse osmosis and nanofiltration cannot operate at pH>8 at high mineral concentrations, because mineral scaling will occur at the surface of the membrane. The effect of this additional process will be to decrease the amount of regenerant needed for the ion exchange system, while potentially reducing the physical footprint of the cell.

In certain embodiments, brucite (e.g., [Mg(OH)₂]) is recycled to act as an alkalinity (e.g., OH) carrier for calcium carbonate precipitation. In certain such embodiments, the cathode may operate at lower pH (<11), which can increase the cell efficiency (e.g., by running at a lower rate of proton generation at the anode, the recycle stream can be reduced, and the physical components of the cell will be less susceptible to corrosion).

In certain embodiments, an ion-selective RO permeate is fed to the electrochemical cell, and the retentate is used only for ion exchange regenerant. In certain such embodiments, a separate feed inlet to the anode is used to implement a recycle stream of neutralized anolyte. In certain embodiments, the recycle rate is proportional to the required rate to limit the proton concentration, not to exceed 0.1 M, or pH<1, thereby allowing for favorable per-pass conversion of minerals while maintaining cell efficiency.

In certain embodiments, a second electrolytic cell is used in series. The use of multiple sequential electrolytic cells would allow production of relatively pure magnesium hydroxide in the first cell, and relatively pure calcium hydroxide in the second cell; allowing in general the separation of precipitated solids based on their pH-based solubility (i.e., via solubility gradient separation). The increased purity of the MgOH₂ and CaOH₂ byproducts in such embodiments provides the advantage of production of possibly saleable products (i.e., commercial grade). In further embodiments, a process to remove excess chloride ion (RO or NF) is employed to minimize the amount of sodium chloride coprecipitated with the product streams. In yet further embodiments, the anolyte stream is neutralized and recycled.

In certain embodiments, free-chlorine species generated during the methods of the disclosure are used as a commercial biocide. In other embodiments, anolyte streams to be recycled are dechlorinated using a dechlorinating agent before recycling. In yet further embodiments, the dechlorinating agent is selected from biochar, activated carbon, iron, and lignite coal. In certain embodiments, chlorine gas generated at the anode is converted to HCl by reaction with hydrogen (H₂). In further embodiments, free-chlorine species are reduced using UV light. In yet further embodiments, an oxygen-selective electrode is used which disfavors chlorine-evolution reactions and favors oxygen-evolution reactions.

In certain aspects, provided herein are methods of sequestering CO₂ comprising:
(a) in a first cathodic chamber, performing a first alkaline process comprising:
   (i) alkalinizing a first solution by contacting the first solution with a cathode disposed within the first cathodic chamber, thereby forming an alkaline solution and producing H₂, wherein the first solution comprises water and divalent alkaline earth ions;
   (ii) contacting the alkaline solution with a CO₂ source, thereby forming a carbonated solution comprising a mixture of salts comprising OH and/or CO₃²⁻;
   (iii) precipitating the salts comprising OH and/or CO₃²⁻ from the carbonated solution;
(b) in a first anodic chamber, performing a first acidic process comprising:
   (i) acidifying a second solution comprising chloride ions by contacting the second solution with an anode disposed within the first anodic chamber, thereby forming an acidic solution; and
   (ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the first cathodic chamber and first anodic chamber are in ionic communication;
the first solution and second solution are aqueous solutions having greater than about 8 parts per thousand (ppt) total dissolved solids; and
the first acidic process and the first alkaline process are performed simultaneously or sequentially.

In certain embodiments, the first solution and second solution each comprise Mg and Ca. In further embodiments, the first solution and second solution further comprise Na.

In some embodiments, methods of the disclosure further comprise isolating the salts comprising OH⁻ and/or CO₃²⁻ from the carbonated solution.

In certain embodiments, methods of the disclosure comprise solutions comprising an amount of total dissolved solids, which represents the totality of the dissolved species in a solution. The dissolved species may include inorganic and organic substances, such as, but not limited to, neutral species, molecular ions, polyatomic ions, or monoatomic ions, or a combination thereof. In certain embodiments, the total dissolved solids comprise magnesium. In some embodiments, the total dissolved solids comprise calcium. In certain embodiments, the total dissolved solids comprise magnesium and calcium. In certain embodiments, the first solution and the second solution each comprise greater than about 10 parts per thousand (ppt) total dissolved solids (e.g., calcium and/or magnesium). In some embodiments, the first solution and the second solution each comprise greater than about 15 ppt total dissolved solids (e.g., calcium and/or magnesium). In certain embodiments, the first solution and the second solution each comprise greater than about 20 ppt total dissolved solids (e.g., calcium and/or magnesium). In some embodiments, the first solution and the second solution each comprise greater than about 25 ppt total dissolved solids (e.g., calcium and/or magnesium). In certain embodiments, the first solution and the second solution each comprise greater than about 30 ppt total dissolved solids (e.g., calcium and/or magnesium). In some embodiments, the first solution and the second solution each comprise greater than about 35 ppt total dissolved solids (e.g., calcium and/or magnesium). In certain embodiments, the first solution and the second solution each comprise greater than about 40 ppt total dissolved solids (e.g., calcium and/or magnesium). In some embodiments, the first solution and the second solution each comprise greater than about 55 ppt total dissolved solids (e.g., calcium and/or magnesium). In certain embodiments, the first solution and the second solution each comprise greater than about 70 ppt total dissolved solids (e.g., calcium and/or magnesium). In some embodiments, the first solution and the second solution each comprise greater than about 85 ppt total dissolved solids (e.g., calcium and/or magnesium). In certain embodiments, the first solution and the second solution each comprise greater than about 100 ppt total dissolved solids (e.g., calcium and/or magnesium). In some embodiments, the first solution and the second solution each comprise greater than about 150 ppt total dissolved solids (e.g., calcium and/or magnesium). In certain embodiments, the first solution and the second solution each comprise greater than about 200 ppt total dissolved solids (e.g., calcium and/or magnesium). In some embodiments, the first solution and the second solution each comprise greater than about 225 ppt total dissolved solids (e.g., calcium and/or magnesium). In certain embodiments, the first solution and the second solution each comprise greater than about 250 ppt total dissolved solids (e.g., calcium and/or magnesium). In some embodiments, the first solution and the second solution each comprise greater than about 500 ppt total dissolved solids (e.g., calcium and/or magnesium).

In certain embodiments, the first alkaline process and first acidic process are performed simultaneously.

In some embodiments, the anode mitigates chlorine evolution reactions (CIER) to less than 25% Faraday efficiency at current densities of 0.001 to 100000 A/m². In certain embodiments, the anode is selective for Oxygen Evolution Reaction (OER). In further embodiments, the anode is greater than about 85% selective for OER. In some embodiments, the anode is greater than about 95% selective for OER. In certain embodiments, the anode is greater than about 98% selective for OER.

In certain embodiments, the anode comprises a group 6, group 7, or group 8 element. In further embodiments, the anode comprises a group 6 element. In other embodiments, the anode comprises a group 7 element. In some embodiments, the anode comprises a group 8 element. In preferred embodiments, the group 7 element is manganese. In certain embodiments, the anode comprises manganese oxide. In some embodiments, the anode further comprises a transition metal additive. In certain preferred embodiments, the anode comprises manganese oxide coated onto a transition metal core. In some such embodiments, the transition metal core comprises titanium.

In some embodiments, the deacidifying agent is selected from an ion exchange resin, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash. In certain preferred embodiments, the deacidifying agent comprises Mg, Fe, Si, and O.

In certain preferred embodiments, the deacidifying agent is an ion exchange resin.

In some embodiments, the dechlorinating agent is selected from Hydrogen sulfide, Sulfur dioxide, Sulfite salts, Copper slag, Fayalite, Ferrosilite, Magnetite, Antigotite, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash. In certain preferred embodiments, the dechlorinating agent comprises Mg, Fe, Si, and O.

In certain preferred embodiments, the deacidifying agent is the dechlorinating agent.

In some embodiments, the CO₂ source comprises from about 400 ppm to about 100% CO₂. In certain preferred embodiments, the CO₂ source comprises about 400 ppm CO₂. In certain embodiments, the CO₂ source is ambient air. In some embodiments, the CO₂ source has the same CO₂ concentration as ambient air. In other embodiments, the CO₂ source has a higher CO₂ concentration than ambient air, such as gaseous effluent from an industrial process. In certain embodiments, the industrial process is selected from oil and gas production, power generation, cement production, or steel production. In some embodiments, the gaseous effluent from an industrial process is concentrated, and the concentrated stream is the CO₂ source. In certain embodiments, the CO₂ source is concentrated CO₂ from direct air capture processes. In some embodiments, the CO₂ is nearly pure or pure CO₂. In further embodiments, the CO₂ source comprises greater than 90% CO₂.

In certain embodiments, the first solution is an aqueous solution produced as a byproduct of oil and gas extraction.

In some embodiments, the second solution is an aqueous solution produced as a byproduct of oil and gas extraction.

In certain embodiments, the first solution and the second solution are from the same source solution.

In some embodiments, the first alkaline process and first acidic process occur in spaces separated by a semi-permeable barrier. In certain such embodiments, the semi-permeable barrier is a semi-permeable membrane. In certain embodiments, the semi-permeable barrier is a semi-permeable membrane (e.g., a membrane made of ion exchange materials (e.g., Nafion), hydrophilic ceramic membrane or plate (e.g., aluminum oxide, zirconium oxide, silicon dioxide, asbestos, hydrous aluminum phyllosilicates, clay, or any combination thereof), polymer (e.g., cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composites). In certain embodiments, the semi-permeable membrane comprises polystyrene, polysulfone, polyethersulfone, polyacrylonitrile, cellulose, polyvinyl chloride, organic rubber, polyolefin, polyethylene, polypropylene, polyvinylidene fluoride, polytetrafluoroethylene, epoxy resin, silicone or a combination thereof.

In some embodiments, the alkaline solution has a pH from about 7 to about 14. In further embodiments, the alkaline solution has a pH from about 10 to about 11. In yet further preferred embodiments, the alkaline solution has a pH of about 10.5.

In certain embodiments, the acidic solution has a pH from about 0.1 to about 7. In further embodiments, the acidic solution has a pH from about 0.5 to 3.5. In yet further preferred embodiments, the acidic solution has a pH of about 1.

In some embodiments, the first acidic process and first alkaline process are performed at a pass conversion from about 5 to about 95. In some embodiments, the first acidic process and first alkaline process are performed at a single pass conversion from about 5 to about 95.

In certain embodiments, methods of the disclosure further comprise forming the first solution and second solution by separating sodium from a source solution.

In some embodiments, separating sodium from the first solution and second solution comprises nanofiltration or reverse osmosis. In certain embodiments, separating sodium from the first solution and second solution comprises nanofiltration. In other embodiments, separating sodium from the first solution and second solution comprises reverse osmosis. In certain embodiments, separating sodium from the first solution and second solution comprises nanofiltration and the nanofiltration selectively concentrates divalent ions (e.g., Mg²⁺ and/or Ca²⁺) while allowing monovalent ions (e.g., Na⁺) to pass through. In some such embodiments, the nanofiltration thereby forms a retentate which has a higher ratio of divalent ions to monovalent ions (e.g., higher ratio of Mg²⁺ and/or Ca²⁺relative to Na⁺) than the first solution and second solution prior to nanofiltration. As will be appreciated by one of ordinary skill in the art, nanofiltration and reverse osmosis have different ion selectivities based on the features of the NF or RO membranes. For a detailed discussion of reverse osmosis and nanofiltration for ion separation, see, e.g., Mulder, M., Basic Principles of Membrane Technology, 2nd ed.; Springer Dordrecht, 1996, and Baker, R. W., Membrane Technology and Applications, Wiley, 2004, the contents of which are hereby incorporated by reference in their entirety.

In certain embodiments, separating sodium from the source solution forms an aqueous permeate solution and an aqueous retentate solution, and the aqueous permeate solution is used for the first solution and the second solution.

In some embodiments, deacidifying the acidic solution comprises contacting the acidic solution with an ion exchange resin. In further embodiments, the ion exchange resin is an anion exchange resin. In certain embodiments, the ion exchange resin is Dupont's Amberlite™ IRA weak base anion exchange resin. In other embodiments, the ion exchange resin is Dupont's Amberlite™ IRA strong base anion exchange resin. In certain embodiments, the ion exchange resin is a polystyrene-based microporous strong base anion resin (e.g., Purolite™). In certain embodiments, the ion exchange resin comprises polystyrene, polysulfone, polyethersulfone, polyacrylonitrile, polytetrafluoroethylene, nylon, or polyethylene, or a combination thereof. In certain embodiments, deacidifying the acidic solution comprises contacting the acidic solution with two or more ion exchange resins, e.g., a combination of two or more of the examples provided above.

In certain embodiments, methods of the disclosure further comprise regenerating the ion exchange resin with the aqueous retentate solution.

In some embodiments, methods of the disclosure further comprise adding Mg(OH)₂ to the first solution before or during the first alkaline process.

In certain embodiments, methods of the disclosure further comprise recycling the deacidified solution by combining the deacidified solution and the second solution.

In some embodiments, methods of the disclosure further comprise performing a second alkaline process in sequence with the first alkaline process.

In certain embodiments, methods of the disclosure further comprise performing a second acidic process in sequence with the first acidic process.

In some preferred embodiments, predominantly Mg(OH)₂ is produced in the first alkaline process. In certain preferred embodiments, predominantly Ca(OH)₂ is produced in the second alkaline process. In some embodiments, the Mg(OH)₂ produced in the first alkaline process and the Ca(OH)₂ produced in the second alkaline process are of a purity greater than 70%. the Mg(OH)₂ produced in the first alkaline process and the Ca(OH)₂ produced in the second alkaline process are of a purity greater than about 70%. In certain embodiments, the Mg(OH)₂ produced in the first alkaline process and the Ca(OH)₂ produced in the second alkaline process are of a purity greater than about 80%. the Mg(OH)₂ produced in the first alkaline process and the Ca(OH)₂ produced in the second alkaline process are of a purity from about 70% to about 100%.

In certain embodiments, methods of the disclosure further comprise separating chloride ions from the Ca(OH)₂ and the Mg(OH)₂ in situ.

In certain aspects, provided herein are systems for the sequestration of CO₂ comprising:
(a) a first cathodic chamber comprising:
   a first cathode
   a first cathodic gas outlet;
   a first solution inlet; and
   a first alkaline solution outlet;
   wherein the first cathode is disposed inside the first cathodic chamber and coupled to a power source; and
(b) a first anodic chamber comprising:
   a first anode;
   a first anodic gas outlet;
   a second solution inlet; and
   a first acidic solution outlet;
   wherein the anode is disposed inside the anodic chamber and coupled to a power source;
wherein the first cathodic chamber and the first anodic chamber are in ionic communication.

In certain embodiments, systems of the disclosure further comprise a dechlorination chamber comprising:
a chlorinated solution inlet;
a dechlorinated solution outlet;
a dechlorinating agent;
wherein the dechlorinating agent is disposed inside the dechlorination chamber, and the chlorinated solution inlet is coupled to the first acidic solution outlet.

In certain embodiments, systems of the disclosure further comprise a deacidification chamber comprising:
an acidic solution inlet;
a deacidified solution outlet;
a deacidifying agent;
wherein the deacidifying agent is disposed inside the deacidification chamber, and the acidic solution inlet of the deacidification chamber is coupled to the dechlorinated solution outlet.

In some embodiments, the alkaline process chamber and the acidic process chamber are separated by a separator. In certain embodiments, the separator is a semi-permeable barrier, such as a semi-permeable membrane (e.g., a membrane made of ion exchange materials (e.g., Nafion), hydrophilic ceramic membrane or plate (e.g., aluminum oxide, zirconium oxide, silicon dioxide, asbestos, hydrous aluminum phyllosilicates, clay, or any combination thereof), polymer (e.g., cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composites). In certain embodiments, the semi-permeable membrane comprises polystyrene, polysulfone, polyethersulfone, polyacrylonitrile, cellulose, polyvinyl chloride, organic rubber, polyolefin, polyethylene, polypropylene, polyvinylidene fluoride, polytetrafluoroethylene, epoxy resin, silicone or a combination thereof.

In some embodiments, the semi-permeable membrane comprises polyvinylidene fluoride (PVDF). In further embodiments, the semi-permeable membrane comprising PVDF has undergone a hydrophilic treatment. In yet further embodiments, the semi-permeable membrane comprising PVDF has a hydrophilic coating and/or surface. In certain embodiments, the semi-permeable membrane is a proton exchange ceramic membrane.

In certain embodiments, systems of the disclosure further comprise a second cathodic chamber comprising:
a second cathode
a second cathodic gas outlet;
a first alkaline solution inlet; and
a second alkaline solution outlet;
wherein the second cathode is disposed inside the second cathodic chamber and coupled to a power source.

In some embodiments, systems of the disclosure further comprise an ion exchange resin disposed inside the deacidification chamber. In further embodiments, the ion exchange resin is an anion exchange resin. In certain embodiments, the ion exchange resin is Dupont's Amberlite™ IRA weak base anion exchange resin. In other embodiments, the ion exchange resin is Dupont's Amberlite™ IRA strong base anion exchange resin. In certain embodiments, the ion exchange resin is a polystyrene-based microporous strong base anion resin (e.g., Purolite™). In certain embodiments, the ion exchange resin comprises polystyrene, polysulfone, polyethersulfone, polyacrylonitrile, polytetrafluoroethylene, nylon, or polyethylene, or a combination thereof. In certain embodiments, deacidifying the acidic solution comprises contacting the acidic solution with two or more ion exchange resins, e.g., a combination of two or more of the examples provided above.

### Definitions

Unless otherwise defined herein, scientific and technical terms used in this application shall have the meanings that are commonly understood by those of ordinary skill in the art. Generally, nomenclature used in connection with, and techniques of, chemistry, chemical engineering, electrical engineering and civil engineering described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

The terms “olivine” and “olivine rock” as used herein may refer to at least one of olivine, comprising Mg, Fe, and SiO₄, and any of the various members of the “Olivine Group,” which includes olivine, tephroite, monticellite, larnite and kirschsteinite. The above olivine species may further comprise other elements, such as, Mg, Fe, Mn, Al, Ti, Ca, Cr, Ni, Co. Olivine may be found in mafic and ultramafic igneous rock.

The terms “deacidifying,” “deacidify,” and “deacidification” as used herein refer to a process that results in an increase in pH of an aqueous solution.

A “deacidifying composition” herein refers to a composition that deacidifies a substrate. Deacidifying compositions include alkaline rocks and minerals containing carbonates, hydroxides, oxides, and/or silicates. As a non-limiting example, olivine rock may, in certain embodiments, be used as a deacidifying composition to deacidify a solution with a low pH.

“Free-chlorine species” as used herein may refer to any chemical compound that comprises or can generate chlorine atoms with an oxidation state greater than or equal to 0. As non-limiting examples, free-chlorine species of the disclosure include Cl₂, ClO⁻, and HClO.

The terms “dechlorinate,” and “dechlorination” as used herein refer to processes that result in the removal of Cl-containing compounds or ions from a substrate such as an aqueous solution. In preferred embodiments, as a non-limiting example, dechlorination includes the chemical conversion of free-chlorine species (e.g., Cl₂, ClO⁻, HClO, etc.) to chloride (Cl⁻) using a dechlorinating composition.

The term “dechlorinating composition” as used herein refers to a composition that facilitates the chemical transformation of free-chlorine species into chlorides.

The term “deacidifying and dechlorinating composition” as used here refers to a composition that advantageously deacidifies (e.g., induces an increase in pH of an aqueous solution and dechlorinates (e.g., facilitates the chemical transformation of free-chlorine species into chlorides) an aqueous solution.

The term “reductive species” as used herein refers to a chemical species which may interact with another chemical species and transfer at least one valence electron to the chemical species, thereby reducing the chemical species. Reductive species may include, but are not limited to, low-valent metallic species.

The term “low-valent metallic species” as used herein refers to chemical species, which exists in a formal oxidation state less than (i.e., lower than) at least one of the most common naturally-occurring non-zero oxidation states. As non-limiting examples, low-valent metal species described herein may include Fe⁰, Fe²⁺, Mn⁰, Mn³⁺, Mn⁴⁺, Ni⁰, Ni⁺, and Ni³⁺. The term “alkalinizing” as used herein refers to a process of increasing the pH of a given solution, e.g., alkalinizing the first solution to prepare an alkaline solution with a higher pH.

The term “acidifying” or “acidification” as used herein refers to a process of decreasing the pH of a given solution. The given solution may be of any starting pH before undergoing the acidifying, e.g., the solution may already have a pH below 7 before a step of acidifying the solution is performed.

The term “ionic communication” as used herein refers to the ability for ions to freely flow between two objects or regions of an object, e.g., between the cathodic chamber and anodic chamber of an electrochemical cell, in accordance with local chemical gradients. Non-limiting examples of such gradients include flow of ions from an area of high electrical potential to low electrical potential, from high ion concentration to low ion concentration, and from high chemical potential to low chemical potential. In certain embodiments, two objects or regions may be physically separated by a semi-permeable barrier (e.g., not in fluid communication) but still be in ionic communication, e.g., by virtue of ion diffusion or transport through the barrier.

### EXAMPLES

The invention now being generally described, it will be more readily understood by reference to the following examples which are included merely for purposes of illustration of certain aspects and embodiments of the present invention, and are not intended to limit the invention.

### Example 1: Exemplary Deacidifying Agents

TABLE 1
List of exemplary deacidifying agents, their descriptions,
and approximate moles of H⁺ neutralized per kg of agent.

| | | Mol H⁺ neutralized |
|---|---|---|
| | | per kg deacidifying |
| Deacidifying Agent | Description | agent |
| Periclase | MgO, a mineral found in | 49.63 |
| | metamorphic rocks | |
| Lime | CaO, naturally occurring or | 35.66 |
| | synthetic | |
| Lime Kiln Dust | By-product of lime | 34.38 |
| | manufacturing | |
| Forsterite | Mg₂SiO₄, the Mg-endmember | 28.43 |
| | of olivine | |
| Olivine | Group of nesosilicate | 25.97 |
| | minerals found in ultramafic | |
| | rocks | |
| Larnite | Ca₂SiO₄, a nesosilicate found | 23.22 |
| | in crystalline slags | |
| Serpentinite | Ultramafic rock rich in | 22.96 |
| | serpentine, a hydrothermal | |
| | alteration product of olivine | |
| Basalt | Fine-grained mafic rock rich | 22.91 |
| | in plagioclase feldspar and | |
| | pyroxene | |
| Stainless steel slag | Semicrystalline by-product of | 22.02 |
| | metal manufacturing | |
| Peridotite | Ultramafic rock rich in olivine | 22.00 |
| | with some pyroxene | |
| Lizardite | Mg₃(Si₂O₅)(OH)₄, a | 21.65 |
| (Serpentine) | phyllosilicate | |
| Ladle slag | Semicrystalline by-product of | 20.40 |
| | metal manufacturing | |
| Blast furnace slag | Semicrystalline by-product of | 19.97 |
| | metal manufacturing | |
| Diopside | CaMgSi₂O₆, a single-chained | 18.47 |
| | inosilicate (pyroxene) | |
| Air-cooled blast | Crystalline by-product of | 17.78 |
| furnace slag | metal manufacturing | |
| Wollastonite | CaSiO₃, a single-chained | 17.22 |
| | inosilicate | |
| Basic oxygen | Semicrystalline by-product of | 16.85 |
| furnace slag | metal manufacturing | |
| Brownmillerite | Ca₂(Al, Fe³⁺)₂O₅, a non- | 16.66 |
| | stoichiometric perovskite | |
| Comingled electric | Semi-crystalline by-product | 16.64 |
| arc furnace slag | of metal manufacturing | |
| Cement kiln dust | Amorphous by-product of | 15.94 |
| | Ordinary Portland Cement | |
| | (OPC) production | |
| Talc | Mg₃Si₄O₁₀(OH)₂, a | 15.82 |
| | phyllosilicate | |
| Electric arc furnace | Semi-crystalline by-product | 15.08 |
| slag | of metal manufacturing | |
| Class C fly ash | High-calcium fly ash from | 13.59 |
| | processing subbituminous and | |
| | lignite coals | |
| Reclaimed Class C | High-calcium fly ash | 13.45 |
| fly ash | reclaimed from landfill | |
| Anorthite | CaAl₂Si₂O₈, Ca-endmember | 9.61 |
| | of plagioclase feldspar, a | |
| | tectosilicate | |
| Trona-rich fly ash | Fly ash containing | 9.44 |
| | Na₃(CO₃)(HCO₃)•2H₂O | |
| Bytownite | Na_{0.2}Ca_{0.8}Al_{1.8}Si_{2.2}O₈, a type | 6.55 |
| | of plagioclase feldspar, a solid | |
| | solution of NaAlSi3O8 and | |
| | CaAl2Si2O8 | |
| Gabbro | Coarse-grained mafic rock | 6.48 |
| | rich in plagioclase feldspar | |
| | and pyroxene | |
| Anorthosite | Fine-grained mafic rock rich | 5.65 |
| | in anorthite | |
| Albite | NaAlSi₃O₈, Na-endmember of | 3.80 |
| | plagioclase feldspar, a | |
| | tectosilicate | |
| Class F fly ash | Low-calcium fly ash from | 1.91 |
| | processing anthracite and | |
| | bituminous coals | |

### Example 2: Results of an Exemplary CO₂ Removal System

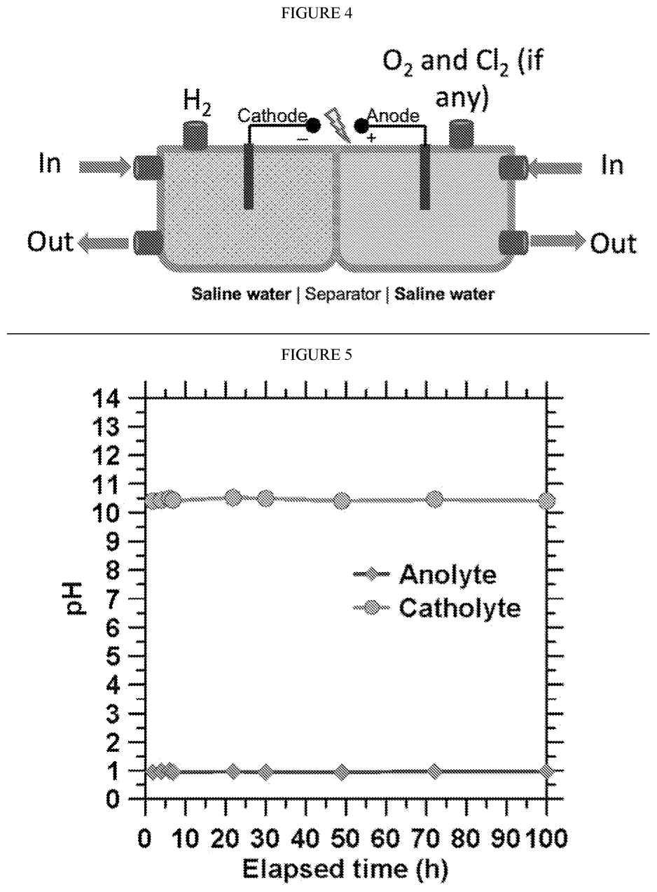

An exemplary two-chamber flow-through reactor (e.g., FIG. 4) was employed with a porous diaphragm used to separate the anolyte and catholyte. Seawater (prepared using the Instant Ocean® salt) was used to flow through the anolyte and catholyte chambers. 316 stainless steel mesh were used as the cathode, while a MnOₓ-coated titanium were used as the anode. In this set up, flowrates of catholyte and anolyte were identical and were controlled by a peristaltic pump. The catholyte pH was maintained at above 10 and the anolyte pH is below 2 through the application of a voltage to the electrode pair (FIG. 5).

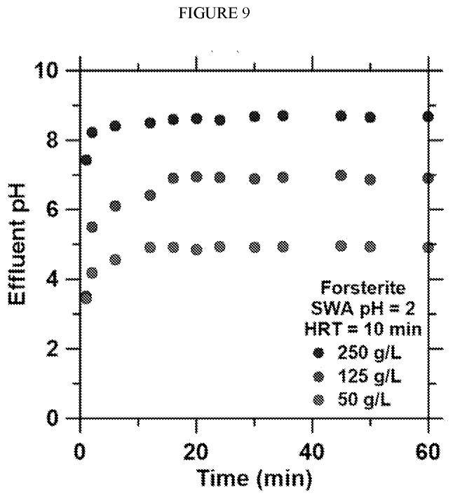

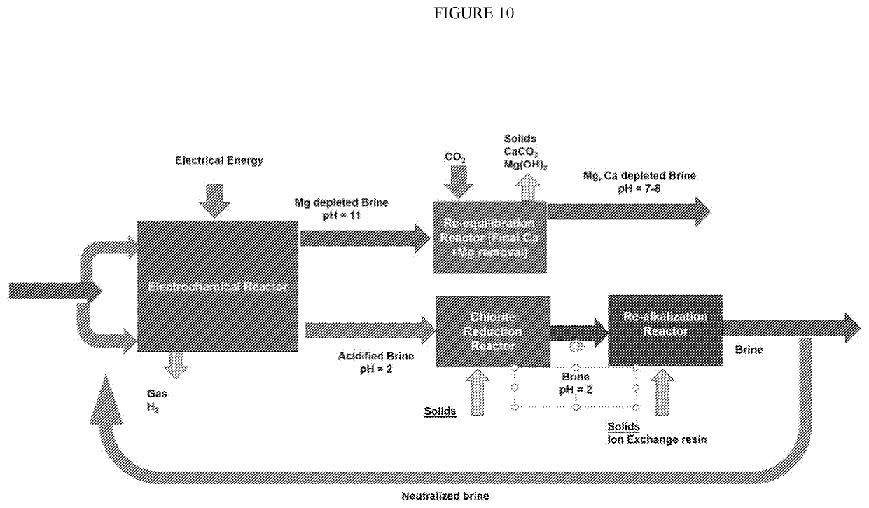

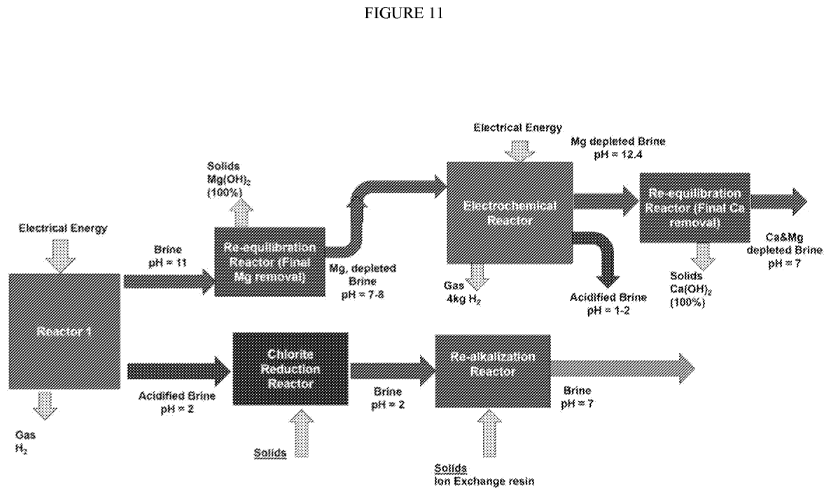

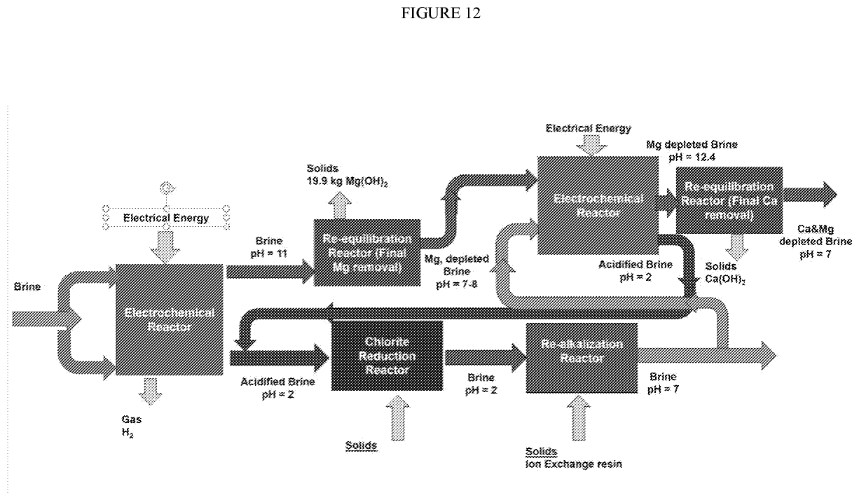

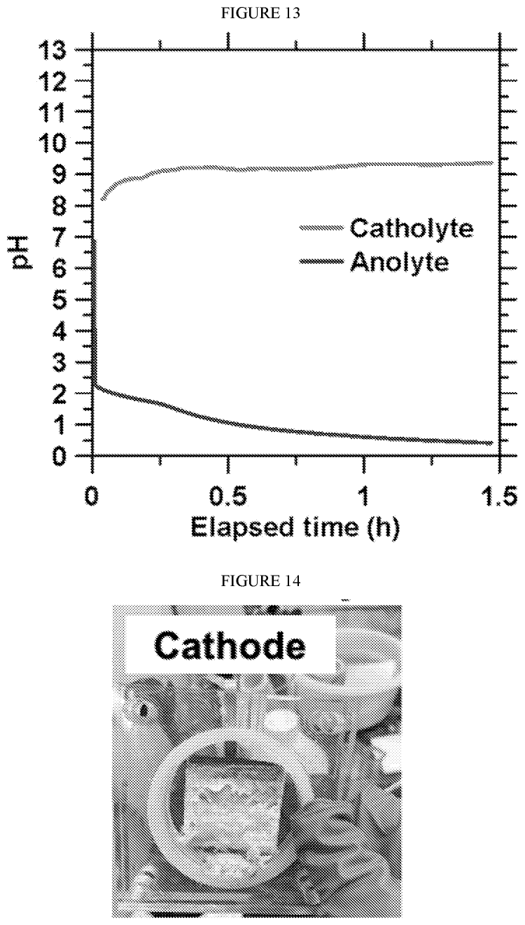

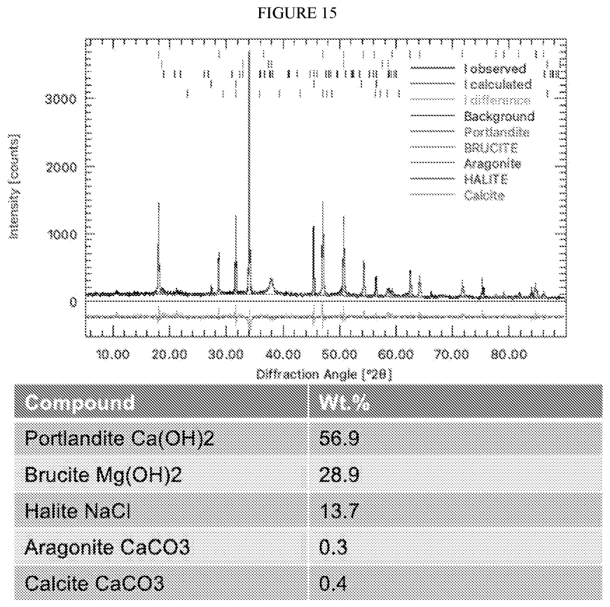

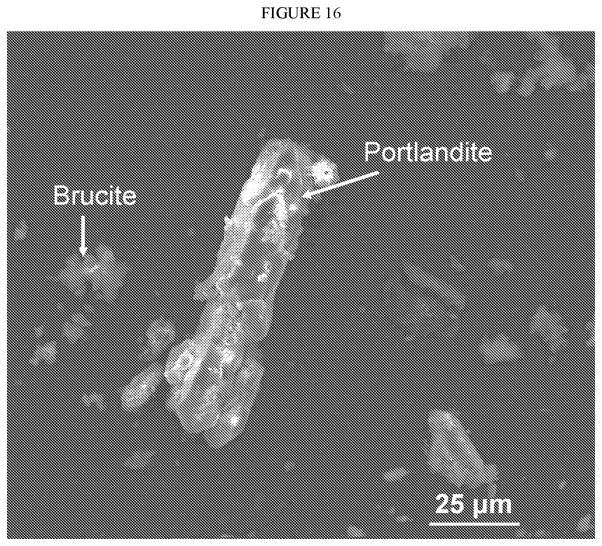

As for anolyte treatment, the use of the manganese oxide-coated anode (FIG. 8, inset) significantly reduced chlorine oxidation during the electrolysis process to approximately 99% (FIG. 8). The remaining free-chlorine species (<100 ppm) can be easily dechlorinated by aforementioned approaches or by using commercial reagents (e.g., activated carbon, SO₂, sulfite salts, etc.), rendering the grand carbon removal process free from generating oxidized chlorine species. In addition, FIG. 9 shows exemplary results of neutralizing the anolyte acidity by using an olivine rock (forsterite). Note that, >99% of the acidity (H⁺) were neutralized even at a low solid loading (50 g/L) under a hydraulic retention time of 10 mins.

### Example 3: Results of an Exemplary Hydroxide Production System

An exemplary two-chamber flow-through reactor (e.g., FIG. 4) was employed with a porous diaphragm used to separate the anolyte and catholyte. A produced water (760 mM Ca, 130 mM Mg, 2.5 M Na, 4 M Cl, trace Fe, Mn, Sr etc.) was used to flow through the anolyte and catholyte chambers. 316 stainless steel mesh were used as the cathode, while a Pt-coated titanium were used as the anode. In this set up, flowrates of catholyte and anolyte were identical and were controlled by a peristaltic pump. The catholyte pH was maintained at above 9 and the anolyte pH is below 2 through the application of a voltage to the electrode pair (FIG. 5).

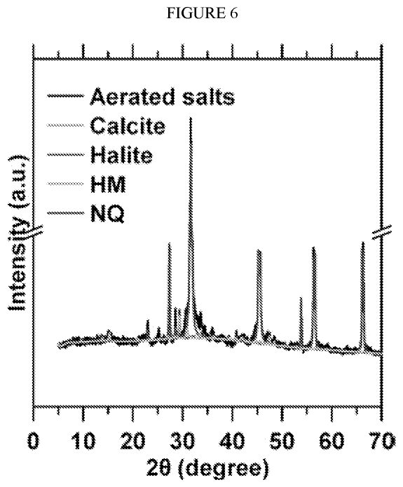

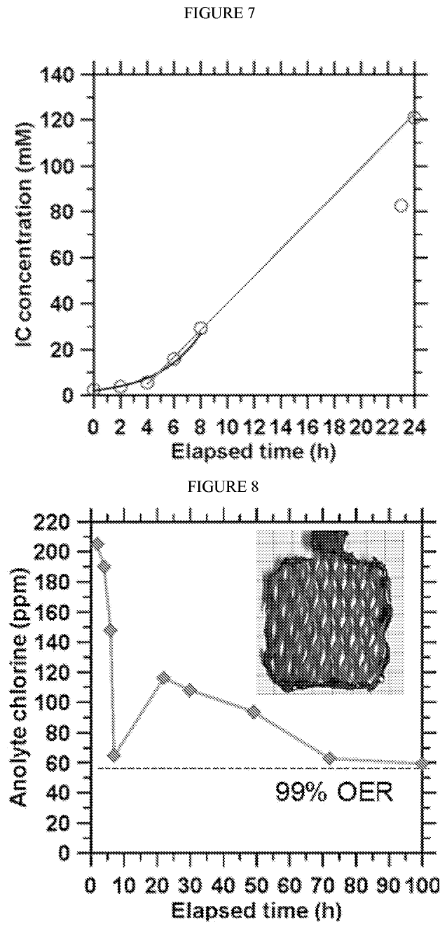

After about 2 h of electrolysis, deposits were identified at the cathode as a thick layer of Ca+Mg hydroxides precipitates (FIG. 6), which later was identified as mostly portlandite and brucite (FIGS. 7-8). The cell efficiency attains 90 (+20) % when producing Ca+Mg hydroxides. Portlandite was produced even at a bulk effluent pH<10, this is due to the high Ca concentration (800 mM), and the pH adjacent to the cathode surface satisfies the precipitation conditions for Ca(OH) 2.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of sequestering CO₂ comprising:
(a) in a first cathodic chamber, performing an alkaline process comprising:
(i) alkalinizing a first solution by contacting the first solution with a cathode disposed inside the cathodic chamber, thereby forming an alkaline solution and H₂, wherein the first solution comprises water and divalent alkaline earth ions;
(ii) contacting the alkaline solution with a CO₂ source, thereby forming a carbonated solution comprising a mixture of ionic compounds, wherein the ionic compounds comprise CO₃²⁻;
(b) in a first anodic chamber, performing an acidic process comprising:
(i) acidifying a second solution comprising chloride ions by contacting the second solution with an anode disposed inside the anodic chamber, thereby forming an acidic solution; and
(ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the cathodic chamber and the anodic chamber are in ionic communication; and
the acidic process and the alkaline process are performed simultaneously or sequentially.

2. The method of any preceding claim, wherein the alkaline process and acidic process are performed simultaneously.

3. The method of any preceding claim, wherein the anode mitigates chlorine evolution reactions (CIER) (e.g., the anode mitigates CIER to less than a 10% Faraday efficiency at current densities of 0.001 to 100000 A/m²).

4. The method of any preceding claim, wherein the anode comprises a group 6, group 7, or group 8 element.

5. The method of claim 4, wherein the anode comprises a group 7 element.

6. The method of claim 5, wherein the group 7 element is manganese.

7. The method of claim 6, wherein the anode comprises manganese oxide.

8. The method of any one of claims 4-7, wherein the anode further comprises a transition metal additive (e.g., one or more transition metal additives or species).

9. The method of claim 8, wherein the anode comprises manganese oxide coated onto a transition metal substrate.

10. The method of claim 9, wherein the transition metal substrate comprises titanium (e.g., titanium coated with a mixed metal oxide (MMO) layer).

11. The method of any preceding claim wherein the deacidifying agent is selected from Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

12. The method of any previous claim, wherein the dechlorinating agent is selected from Hydrogen sulfide, Sulfur dioxide, Sulfite salts, Copper slag, Fayalite, Ferrosilite, Magnetite, Antigotite, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

13. The method of any one of claims 1-12 wherein the deacidifying agent is the dechlorinating agent.

14. The method of any preceding claim, wherein the CO₂ source comprises from about 400 ppm to about 100% CO₂.

15. The method of any preceding claim, wherein the CO₂ source is ambient air.

16. The method of any one of claims 1-10, wherein the CO₂ source has a higher CO₂ concentration than ambient air, such as flue gas from an industrial process or concentrated CO₂ from direct air capture processes.

17. The method of any preceding claim, wherein the first solution is selected from seawater, desalination brine, industrial brine, and natural brine.

18. The method of any preceding claim, wherein the second solution is selected from seawater, desalination brine, industrial brine, and natural brine.

19. The method of any preceding claim, wherein the first solution and the second solution are from the same source solution.

20. The method of any preceding claim, wherein the alkaline process and acidic process occur in spaces separated by a semi-permeable barrier.

21. The method of claim 20, wherein the semi-permeable barrier is a semi-permeable membrane.

22. The method of any previous claim, wherein the alkaline solution has a pH from about 7 to about 14.

23. The method of claim 22, wherein the alkaline solution has a pH from about 10 to about 11.

24. The method of claim 23, wherein the alkaline solution has a pH of about 10.5.

25. The method of any previous claim, wherein the acidic solution has a pH from about 0.1 to about 7.

26. The method of claim 25, wherein the acidic solution has a pH from about 0.5 to 1.5.

27. The method of claim 26, wherein the acidic solution has a pH of about 1.

28. A system for the sequestration of CO₂ comprising:
(a) an cathodic chamber comprising:
a cathode
an cathodic gas outlet;
a first solution inlet; and
an alkaline solution outlet;
wherein the cathode is disposed inside the cathodic chamber and coupled to a power source; and
(b) an anodic chamber comprising:
an anode;
an anodic gas outlet;
a second solution inlet; and
an acidic solution outlet;
wherein the anode is disposed inside the anodic chamber and coupled to a power source,
wherein the cathodic chamber and the anodic chamber are in ionic communication.

29. The system of claim 28, further comprising a deacidification chamber comprising:
an acidic solution inlet;
a deacidified solution outlet;
a deacidifying agent;
wherein the deacidifying agent is disposed inside the deacidification chamber, and the acidic solution inlet of the deacidification chamber is coupled to the acidic solution outlet.

30. The system of claim 28 or 29, further comprising a dechlorination chamber comprising:
a chlorinated solution inlet;
a dechlorinated solution outlet;
a dechlorinating agent;
wherein the dechlorinating agent is disposed inside the dechlorination chamber, and the chlorinated solution inlet is coupled to the deacidified solution outlet, when present, or the acidic solution outlet.

31. The system of any one of claims 28-30, wherein the alkaline process chamber and the acidic process chamber are separated by a separator.

32. The system of claim 31, wherein the separator is a semi-permeable barrier, such as a semi-permeable membrane (e.g., a membrane made of ion exchange materials (e.g., Nafion), hydrophilic ceramic membrane or plate (e.g., aluminum oxide, zirconium oxide, silicon dioxide, asbestos, hydrous aluminum phyllosilicates, clay, or any combination thereof), polymer (e.g., cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composites).

33. A method of sequestering CO₂ comprising:
(a) in a first cathodic chamber, performing a first alkaline process comprising:
(i) alkalinizing a first solution by contacting the first solution with a cathode disposed within the first cathodic chamber, thereby forming an alkaline solution and producing H₂, wherein the first solution comprises water and divalent alkaline earth ions;
(ii) contacting the alkaline solution with a CO₂ source, thereby forming a carbonated solution comprising a mixture of salts comprising OH and/or CO₃²⁻;
(iii) precipitating the salts comprising OH and/or CO₃²⁻ from the carbonated solution;
(b) in a first anodic chamber, performing a first acidic process comprising:
(i) acidifying a second solution comprising chloride ions by contacting the second solution with an anode disposed within the first anodic chamber, thereby forming an acidic solution; and
(ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the first cathodic chamber and first anodic chamber are in ionic communication;
the first solution and second solution are aqueous solutions having greater than about 8 parts per thousand (ppt) total dissolved solids; and
the first acidic process and the first alkaline process are performed simultaneously or sequentially.

34. The method of claim 33, wherein the first solution and second solution each comprise Mg and Ca.

35. The method of claim 34, wherein the first solution and second solution further comprise Na.

36. The method of any one of claims 33-35, further comprising isolating the salts comprising OH and/or CO₃²⁻ from the carbonated solution.

37. The method of any one of claims 33-36, wherein the first solution and the second solution each comprise greater than about 10 parts per thousand (ppt) total dissolved solids (e.g., calcium and/or magnesium).

38. The method of any one of claims 33-37, wherein the first solution and the second solution each comprise greater than about 15 ppt total dissolved solids (e.g., calcium and/or magnesium).

39. The method of any one of claims 33-38, wherein the first solution and the second solution each comprise greater than about 20 ppt total dissolved solids (e.g., calcium and/or magnesium).

40. The method of any one of claims 33-39, wherein the first solution and the second solution each comprise greater than about 25 ppt total dissolved solids (e.g., calcium and/or magnesium).

41. The method of any one of claims 33-40, wherein the first solution and the second solution each comprise greater than about 30 ppt total dissolved solids (e.g., calcium and/or magnesium).

42. The method of any one of claims 33-41, wherein the first solution and the second solution each comprise greater than about 35 ppt total dissolved solids (e.g., calcium and/or magnesium).

43. The method of any one of claims 33-42, wherein the first solution and the second solution each comprise greater than about 40 ppt total dissolved solids (e.g., calcium and/or magnesium).

44. The method of any one of claims 33-43, wherein the first solution and the second solution each comprise greater than about 55 ppt total dissolved solids (e.g., calcium and/or magnesium).

45. The method of any one of claims 33-44, wherein the first solution and the second solution each comprise greater than about 70 ppt total dissolved solids (e.g., calcium and/or magnesium).

46. The method of any one of claims 33-45, wherein the first solution and the second solution each comprise greater than about 85 ppt total dissolved solids (e.g., calcium and/or magnesium).

47. The method of any one of claims 33-46, wherein the first solution and the second solution each comprise greater than about 100 ppt total dissolved solids (e.g., calcium and/or magnesium).

48. The method of any one of claims 33-47, wherein the first solution and the second solution each comprise greater than about 150 ppt total dissolved solids (e.g., calcium and/or magnesium).

49. The method of any one of claims 33-48, wherein the first solution and the second solution each comprise greater than about 200 ppt total dissolved solids (e.g., calcium and/or magnesium).

50. The method of any one of claims 33-49, wherein the first solution and the second solution each comprise greater than about 225 ppt total dissolved solids (e.g., calcium and/or magnesium).

51. The method of any one of claims 33-50, wherein the first solution and the second solution each comprise greater than about 250 ppt total dissolved solids (e.g., calcium and/or magnesium).

52. The method of any one of claims 33-51, wherein the first solution and the second solution each comprise greater than about 500 ppt total dissolved solids (e.g., calcium and/or magnesium).

53. The method of any one of claims 33-52, wherein the first alkaline process and first acidic process are performed simultaneously.

54. The method of any one of claims 33-53, wherein the anode mitigates chlorine evolution reactions (CIER) to less than 25% Faraday efficiency at current densities of 0.001 to 100000 A/m².

55. The method of any one of claims 33-54, wherein the anode comprises a group 6, group 7, or group 8 element.

56. The method of claim 55, wherein the anode comprises a group 7 element.

57. The method of claim 56, wherein the group 7 element is manganese.

58. The method of claim 55, wherein the anode comprises manganese oxide.

59. The method of any one of claims 55-58, wherein the anode further comprises a transition metal additive.

60. The method of claim 55, wherein the anode comprises manganese oxide coated onto a transition metal core.

61. The method of claim 60, wherein the transition metal core comprises titanium.

62. The method of any one of claims 33-61, wherein the deacidifying agent is selected from an ion exchange resin, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

63. The method of claim 62, wherein the deacidifying agent is an ion exchange resin.

64. The method of any one of claims 33-63, wherein the dechlorinating agent is selected from Hydrogen sulfide, Sulfur dioxide, Sulfite salts, Copper slag, Fayalite, Ferrosilite, Magnetite, Antigotite, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

65. The method of any one of claims 33-64, wherein the deacidifying agent is the dechlorinating agent.

66. The method of any one of claims 33-65, wherein the CO₂ source comprises from about 400 ppm to about 100% CO₂, preferably about 400 ppm.

67. The method of any one of claims 33-66, wherein the CO₂ source is ambient air.

68. The method of any one of claims 33-67, wherein the CO₂ source has a higher CO₂ concentration than ambient air, such as gaseous effluent from an industrial process (e.g., oil and gas production, power generation, cement production, or steel production), and concentrated CO₂ from direct air capture processes (e.g., nearly pure or pure-CO₂).

69. The method of any one of claims 33-68, wherein the first solution is an aqueous solution produced as a byproduct of oil and gas extraction.

70. The method of any one of claims 33-69, wherein the second solution is an aqueous solution produced as a byproduct of oil and gas extraction.

71. The method of any one of claims 33-70, wherein the first solution and the second solution are from the same source solution.

72. The method of any one of claims 33-71, wherein the first alkaline process and first acidic process occur in spaces separated by a semi-permeable barrier.

73. The method of claim 72, wherein the semi-permeable barrier is a semi-permeable membrane.

74. The method of any one of claims 33-74, wherein the alkaline solution has a pH from about 7 to about 14.

75. The method of claim 74, wherein the alkaline solution has a pH from about 10 to about 11.

76. The method of claim 75, wherein the alkaline solution has a pH of about 10.5.

77. The method of any one of claims 33-76, wherein the acidic solution has a pH from about 0.1 to about 7.

78. The method of claim 77, wherein the acidic solution has a pH from about 0.5 to 3.5.

79. The method of claim 78, wherein the acidic solution has a pH of about 1.

80. The method of any one of claims 33-79, wherein the first acidic process and first alkaline process are performed at a pass conversion from about 5 to about 95.

81. The method of any one of claims 33-80, further comprising forming the first solution and second solution by separating sodium from a source solution.

82. The method of claim 81, wherein separating sodium from the first solution and second solution comprises nanofiltration or reverse osmosis.

83. The method of claim 82, wherein separating sodium from the source solution forms an aqueous permeate solution and an aqueous retentate solution, and the aqueous permeate solution is used for the first solution and the second solution.

84. The method of claim 83, wherein deacidifying the acidic solution comprises contacting the acidic solution with an ion exchange resin.

85. The method of claim 84, further comprising regenerating the ion exchange resin with the aqueous retentate solution.

86. The method of any one of claims 33-85, further comprising adding Mg(OH)₂ to the first solution before or during the first alkaline process.

87. The method of any one of claims 33-86, further comprising recycling the deacidified solution by combining the deacidified solution and the second solution.

88. The method of any one of claims 33-87, further comprising performing a second alkaline process in sequence with the first alkaline process.

89. The method of claim 88, further comprising performing a second acidic process in sequence with the first acidic process.

90. The method of claim 88, wherein predominantly Mg(OH)₂ is produced in the first alkaline process.

91. The method of claim 90, wherein predominantly Ca(OH)₂ is produced in the second alkaline process.

92. The method of claim 91, wherein the Mg(OH)₂ produced in the first alkaline process and the Ca(OH)₂ produced in the second alkaline process are of a purity greater than 70%.

93. The method of any one of claims 89-92, further comprising separating chloride ions from the Ca(OH)₂ and the Mg(OH)₂ in situ.

94. A system for the sequestration of CO₂ comprising:
(a) a first cathodic chamber comprising:
a first cathode
a first cathodic gas outlet;
a first solution inlet; and
a first alkaline solution outlet;
wherein the first cathode is disposed inside the first cathodic chamber and coupled to a power source; and
(b) a first anodic chamber comprising:
a first anode;
a first anodic gas outlet;
a second solution inlet; and
a first acidic solution outlet;
wherein the anode is disposed inside the anodic chamber and coupled to a power source;
wherein the first cathodic chamber and the first anodic chamber are in ionic communication.

95. The system of claim 94, further comprising a dechlorination chamber comprising:
a chlorinated solution inlet;
a dechlorinated solution outlet;
a dechlorinating agent;
wherein the dechlorinating agent is disposed inside the dechlorination chamber, and the chlorinated solution inlet is coupled to the first acidic solution outlet.

96. The system of claim 95, further comprising a deacidification chamber comprising:
an acidic solution inlet;
a deacidified solution outlet;
a deacidifying agent;
wherein the deacidifying agent is disposed inside the deacidification chamber, and the acidic solution inlet of the deacidification chamber is coupled to the dechlorinated solution outlet.

97. The system of any one of claims 94-96, wherein the alkaline process chamber and the acidic process chamber are separated by a separator.

98. The system of claim 97, wherein the separator is a semi-permeable barrier, such as a semi-permeable membrane.

99. The system of any one of claims 94-98, further comprising a second cathodic chamber comprising:
a second cathode
a second cathodic gas outlet;
a first alkaline solution inlet; and
a second alkaline solution outlet;
wherein the second cathode is disposed inside the second cathodic chamber and coupled to a power source.

100. The system of any one of claims 96-99, further comprising an ion exchange resin disposed inside the deacidification chamber.

101. The method of any one of claims 1-27 and 33-93, wherein the deacidifying agent comprises Mg, Fe, Si, and O.

102. The method of any one of claims 1-27, 33-93, and 101, wherein the deacidifying agent is olivine.

103. The method of any one of claims 1-27 and 33-93, wherein the deacidifying agent is an ion exchange resin.

104. The method of claim 103, wherein the ion exchange resin is an anion exchange resin.

105. The method of claim 104, wherein the anion exchange resin comprises polystyrene, polysulfone, polyethersulfone, polyacrylonitrile, polytetrafluoroethylene, nylon, or polyethylene, or a combination thereof.

106. The method of any one of claims 1-27 and 33-93, wherein the dechlorinating agent comprises Mg, Fe, Si, and O.

107. The method of any one of claims 1-27, 33-93, and 101-106, wherein the first alkaline process and first acidic process occur in spaces separated by a semi-permeable barrier.

108. The method of claim 107, wherein the semi-permeable barrier is a semi-permeable membrane.

109. The method of claim 108, wherein the semi-permeable membrane comprises ion exchange materials (e.g., Nafion), hydrophilic ceramic membrane or plate (e.g., aluminum oxide, zirconium oxide, silicon dioxide, asbestos, hydrous aluminum phyllosilicates, clay, or any combination thereof), polymer (e.g., polystyrene, polysulfone, polyethersulfone, polyacrylonitrile, cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composites.

110. The method of claim 108, wherein the semi-permeable membrane comprises polyvinylidene fluoride (PVDF).

111. The method of claim 110, wherein the semi-permeable membrane further comprises a hydrophilic coating.

112. The method of claim 108, wherein the semi-permeable membrane comprises a proton exchange ceramic membrane.

113. The system of any one of claims 28-32 and 93-100, wherein the deacidifying agent comprises Mg, Fe, Si, and O.

114. The system of any one of claims 28-32, 93-100, and 113, wherein the deacidifying agent is olivine.

115. The system of any one of claims 28-32 and 93-100, wherein the deacidifying agent is an ion exchange resin.

116. The system of claim 115, wherein the ion exchange resin is an anion exchange resin.

117. The system of claim 116, wherein the anion exchange resin comprises polystyrene, polysulfone, polyethersulfone, polyacrylonitrile, polytetrafluoroethylene, nylon, or polyethylene, or a combination thereof.

118. The system of any one of claims 28-32 and 93-100, wherein the dechlorinating agent comprises Mg, Fe, Si, and O.

119. The system of any one of claims 28-32, 93-100, and 113-118, wherein the alkaline process chamber and the acidic process chamber are separated by a semi-permeable barrier.

120. The system of claim 119, wherein the semi-permeable barrier is a semi-permeable membrane.

121. The system of claim 120, wherein the semi-permeable membrane comprises ion exchange materials (e.g., Nafion), hydrophilic ceramic membrane or plate (e.g., aluminum oxide, zirconium oxide, silicon dioxide, asbestos, hydrous aluminum phyllosilicates, clay, or any combination thereof), polymer (e.g., polystyrene, polysulfone, polyethersulfone, polyacrylonitrile, cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composites.

122. The system of claim 120, wherein the semi-permeable membrane comprises polyvinylidene fluoride (PVDF).

123. The system of claim 122, wherein the semi-permeable membrane further comprises a hydrophilic coating.

124. The system of claim 120, wherein the semi-permeable membrane comprises a proton exchange ceramic membrane.
